(19) United States
(12) Patent Application Publication
(10) Pub. No.: US 2016/0134190 A1
(43) Pub. Date: May 12, 2016

(54) VOLTAGE CONVERTER

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Tsuguo NISHIMURA, Yokkaichi-shi (JP)

(73) Assignees: AutoNetWorks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 14/890,291

(22) PCT Filed: Apr. 23, 2014
(86) PCT No.: PCT/JP2014/061461

§ 371 Date: Nov. 10, 2015

(30) Foreign Application Priority Data
May 13, 2013 (JP) 2013-101593

(51) Int. Cl. H02M 3/158

(52) U.S. Cl. CPC H02M 3/158

(57) ABSTRACT

A voltage converter in which switching between step-down conversion and step-up conversion is performed constantly, without being affected by a voltage drop of a circuit element, and temperature change and variation of the circuit element. The voltage converter includes a step-down PWM signal generation circuit and a step-up PWM signal generation circuit and component for increasing the step-down target voltage.

The present application relates to a voltage converter that subjects an input voltage to step-down conversion or step-up conversion to obtain a target voltage and outputs the obtained voltage, and includes: a step-down switching element that performs switching of the input voltage with PWM (Pulse Width Modulation) control in order to lower the input voltage; and a step-up switching element that performs switching between the input voltage and a fixed potential with the PWM control in order to increase the input voltage.

### BACKGROUND

FIG. 8 is a circuit diagram illustrating an example of a configuration of a conventional voltage converter.

In such a voltage converter, a DC input voltage Vin is supplied to the drain of an N-channel type MOSFET (Metal Oxide Semiconductor Field Effect Transistor) 2, and the source of the FET 2 is connected to one terminal of a coil 1 and the cathode of a diode 4. The anode of the diode 4 is grounded and the other terminal of the coil 1 is connected to the drain of an N-channel type MOSFET 3 and the anode of a diode 5.

The source of the FET 3 is grounded, the anode of the diode 5 is connected to the positive terminal of a smoothing capacitor C3, and the negative terminal of the smoothing capacitor C3 is grounded.

The FETs 2 and 3 are individually connected to a control unit 6, and are subjected to PWM control by the control unit 6.

An output voltage Vout of this voltage converter is output across the two terminals of the smoothing capacitor C3, and the input voltage Vin and the output voltage Vout are detected and read by the control unit 6.

In a voltage converter having such a configuration, the control unit 6 supplies a step-down PWM signal and a step-up PWM signal that have duty ratios as shown in FIG. 9 to the gates of the FETs 2 and 3, in order to obtain the output voltage Vout based on a desired input/output voltage ratio Vout/Vin.

That is, when the input/output voltage ratio is smaller than 1 (Vout/Vin<1) and the input voltage Vin is to be dropped, the duty ratio of the step-down PWM signal depends on the input/output voltage ratio Vout/Vin, and the closer the input/output voltage ratio Vout/Vin is to 1, the closer the duty ratio of the step-down PWM signal is to 100%. In this case, the duty ratio of the step-up PWM signal is 0%, and the FET 3 is in the off-state.

When the input/output voltage ratio is greater than 1 (Vout/Vin>1) and the input voltage Vin is to be boosted, the duty ratio of the step-up PWM signal depends on the input/output voltage ratio Vout/Vin, and the greater the input/output voltage ratio Vout/Vin is than 1, the greater the duty ratio of the step-up PWM signal is than 0%. In this case, the duty ratio of the step-down PWM signal is 100%, and the FET 2 is in the on-state.

Patent Document 1 provides a power supply circuit that sets a step-down mode in which a second semiconductor switching element is normally turned off and a first semiconductor switching element is turned on/off with a predetermined on-duty, for a period in which an input voltage is much higher than an output voltage, that is, a period in which an operation amount is a given value “a” or less. A step-up mode in which the first semiconductor switching element is normally turned on and the second semiconductor switching element is turned on/off with a predetermined on-duty is set for a period in which the input voltage is much lower than the output voltage, that is, a period in which the operation amount is a given value “b” or more. A step-up and step-down mode in which the first and second semiconductor switching elements are respectively controlled with appropriate on-duties is set for a period in which a difference in potential between the input voltage and the output voltage is small, that is, a period in which the operation amount is greater than “a” and smaller than “b”. Accordingly, with a simple control method, switching control based on a difference between an input voltage and an output voltage is performed.

Patent Document 2 provides a power supply device that includes a step-down chopper transistor and a step-up chopper transistor that are connected to the same choke coil, an input voltage determination circuit that compares and determines the dimensions of the input voltage and a predetermined output voltage, and a switching circuit that selectively operates the step-down chopper transistor and the step-up chopper transistor based on an output from this input voltage determination circuit.
Patent Document 1: JP 2012-29362A
Patent Document 2: JP S62-18970A

### SUMMARY

In the above-described conventional voltage converter, when, for example, step-down conversion is switched to step-up conversion, it is preferable as shown in FIG. 10A that the duty ratio of the step-up PWM signal start increasing from 0% at the same time when the duty ratio of the step-down PWM signal reaches 100%. Furthermore, at that time, it is preferable that the output voltage Vout smoothly increase as shown in FIG. 10B, and the output current continues to flow constantly (seamlessly) as shown in FIG. 10C.

Although determination of switching from step-down conversion to step-up conversion is possible by comparing the input voltage Vin with the output voltage Vout, there is the problem that a voltage drop (FIG. 10A) of the output voltage Vout that is caused by the circuit elements within the voltage converter, and temperature change and variation of the circuit element need to be taken into consideration.

For example, if, as shown in FIG. 11A, the switching from step-down conversion to step-up conversion is performed too early, the voltage will suddenly be boosted and a portion PA in which the output voltage increases discontinuously is created, as shown in FIG. 11B.

Furthermore, if, as shown in FIG. 12A, the switching from step-down conversion to step-up conversion is performed too late, the voltage boost is delayed accordingly and thus a portion PB in which the output voltage does not increase is created, as shown in FIG. 12B.

The present application was made in view of the above-described circumstances, and it is an object to provide a voltage converter in which switching between step-down conversion and step-up conversion is performed seamlessly, without being affected by a voltage drop of a circuit element and temperature change and variation of the circuit element at the time of the switching between step-down conversion and step-up conversion.

A voltage converter according to the present application subjects an input voltage to step-down conversion or step-up conversion to obtain a target voltage, and outputs the obtained voltage, the voltage converter including: a step-down switching element and a step-up switching element that are respectively configured to perform, with PWM control, switching of the input voltage, and switching between the input voltage and a fixed potential in order to increase or decrease the input voltage; a component configured to increase or decrease a target voltagea step-down PWM signal generation circuit configured to detect a difference between an output voltage obtained by subjecting the input voltage to the step-down conversion and a step-down target voltage, and to generate a PWM signal for use in the PWM control of the step-down switching element based on the detected difference; a step-up PWM signal generation circuit configured to detect a difference between an output voltage obtained by subjecting the input voltage to the step-up conversion and a step-up target voltage, and to generate a PWM signal for use in the PWM control of the step-up switching element based on the detected difference; and a component for making the step-down target voltage, which is a target for the control by the step-down PWM signal generation circuit, larger by a predetermined amount than the step-up target voltage, which is a target for the control by the step-up PWM signal generation circuit, and when the step-down target voltage and the step-up target voltage are changed, switching between the step-down conversion and step-up conversion of the input voltage is performed in a constant manner.

In this voltage converter, the step-down switching element and the step-up switching element, which are to perform switching, may respectively perform, with PWM control, switching of an input voltage, and switching between the input voltage and a fixed potential in order to increase or decrease the input voltage, subject the input voltage to step-down conversion or step-up conversion to obtain a target voltage, and output the obtained voltage.

The step-down PWM signal generation circuit may detect a difference between an output voltage obtained by subjecting the input voltage to the step-down conversion and the step-down target voltage, and generates a PWM signal for use in the PWM control of the step-down switching element based on the detected difference. The step-up PWM signal generation circuit may detect a difference between an output voltage obtained by subjecting the input voltage to the step-up conversion and the step-up target voltage, and generates a PWM signal for use in the PWM control of the step-up switching element based on the detected difference. The increasing means increases the step-down target voltage, which is a target for the control by the step-down PWM signal generation circuit, by a predetermined amount larger than the step-up target voltage, which is a target for the control by the step-up PWM signal generation circuit. Accordingly, a state in which the duty ratio of the PWM signal generated by the step-up PWM signal generation circuit is larger than a lower limit, and a state in which the duty ratio of the PWM signal generated by the step-down PWM signal generation circuit is smaller than an upper limit occur at the same time.

According to the voltage converter of the present application, it is possible to realize a voltage converter in which switching between step-down conversion and step-up conversion is performed seamlessly, without being affected by a voltage drop of a circuit element and temperature change and variation of the circuit element at the time of the switching between step-down conversion and step-up conversion.

### BRIEF DESCRPTION OF THE DRAWINGS

FIG. 1 is a circuit diagram illustrating a configuration of a voltage converter according to an embodiment of the present application.

FIG. 2 is a characteristic diagram illustrating target voltages and duty ratios of the voltage converter according to an embodiment of the present application.

FIG. 3 is a diagram illustrating an operation of the voltage converter.

FIG. 4A is a diagram illustrating an operation of the voltage converter according to an embodiment of the present application.

FIG. 4B is a diagram illustrating an operation of the voltage converter according to an embodiment of the present application.

FIG. 4C is diagram illustrating an operation of the voltage converter according to an embodiment of the present application.

FIG. 5 is a diagram illustrating an operation of the voltage converter according to an embodiment of the present application.

FIG. 6 is a diagram illustrating an operation of the voltage converter according to an embodiment of the present application.

FIG. 7 is a circuit diagram illustrating an internal configuration of a control unit of a voltage converter according to an embodiment of the present application.

FIG. 8 is a circuit diagram illustrating an example of a configuration of a conventional voltage converter.

FIG. 9 is a characteristic diagram illustrating the duty ratio of the conventional voltage converter.

FIG. 10A is a diagram illustrating an example of the operation of the conventional voltage converter.

FIG. 10B is a diagram illustrating an example of the operation of the conventional voltage converter.

FIG. 10C is a diagram illustrating an example of the operation of the conventional voltage converter.

FIG. 11A is a diagram illustrating an example of the operation of the conventional voltage converter.

FIG. 11B is a diagram illustrating an example of the operation of the conventional voltage converter.

FIG. 12A is a diagram illustrating an example of the operation of the conventional voltage converter.

FIG. 12B is a diagram illustrating an example of the operation of the conventional voltage converter.

### DETAILED DESCRIPTION

Hereinafter, the present application will be described with reference to the drawings illustrating embodiments thereof.

### Embodiment 1

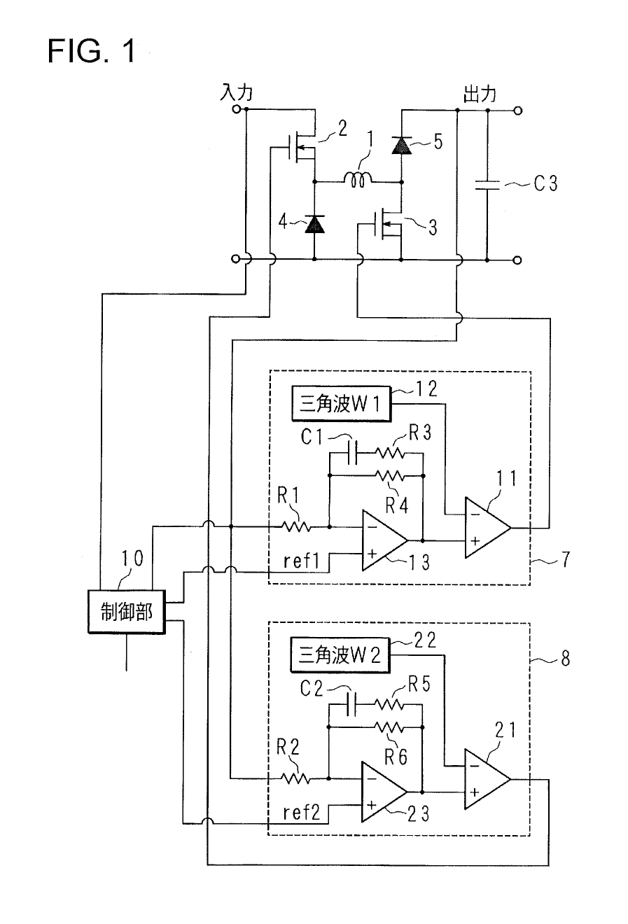

FIG. 1 is a circuit diagram illustrating a configuration of a voltage converter according to Embodiment 1.

In this voltage converter, a DC input voltage Vin may be supplied to the drain of an N-channel type MOSFET 2, and the source of the FET 2 may be connected to one terminal of a coil 1 and the cathode of a diode 4. The anode of the diode 4 is grounded and the other termination of the coil 1 may be connected to the drain of an N-channel type MOSFET 3 and the anode of a diode 5.

The source of the FET 3 is grounded, and the anode of the diode 5 may be connected to the positive terminal of a smoothing capacitor C3, and the negative terminal of the smoothing capacitor C3 is grounded.

The gate of the FET 2 may be connected to a step-down PWM signal generation circuit 8, the gate of the FET 3 may be connected to a step-up PWM signal generation circuit 7, and the FETs 2 and 3 may be respectively subjected to PWM control by the step-down PWM signal generation circuit 8 and the step-up PWM signal generation circuit 7.

An output voltage Vout of the voltage converter may be output across the two terminals of the smoothing capacitor C3, and the input voltage Vin and the output voltage Vout are detected and read by a control unit 10 including a microcomputer. Furthermore, the output voltage Vout may be supplied to the step-down PWM signal generation circuit 8 and the step-up PWM signal generation circuit 7.

The step-up PWM signal generation circuit 7 may include an error amplifier 13 that has an inverting input terminal to which the output voltage Vout is supplied via a resistor R1 and a non-inverting input terminal to which a target voltage ref1 (step-up target voltage) is supplied from the control unit 10, and a triangular wave generator circuit 12 that oscillates and generates a triangular wave signal W1. Furthermore, a comparator 11 may be provided that has an inverting input terminal to which the triangular wave signal W1 is supplied from the triangular wave generator circuit 12 and a non-inverting input terminal to which an output signal from the error amplifier 13 is supplied, and supplies an output signal to the gate of the FET 3.

A negative feedback circuit in which a resistor R4 is connected in parallel to a resistor R3 and a capacitor C1, which are connected in series, may be externally added to the error amplifier 13, and the gain of the error amplifier 13 is small.

The step-down PWM signal generation circuit 8 may include an error amplifier 23 that has an inverting input terminal to which the output voltage Vout is supplied via a resistor R2 and a non-inverting input terminal to which a target voltage ref2 (step-down target voltage) is supplied from the control unit 10, and a triangular wave generator circuit 22 that oscillates and generates a triangular wave signal W2. Furthermore, a comparator 21 may be provided that has an inverting input terminal to which the triangular wave signal W2 is supplied from the triangular wave generator circuit 22 and a non-inverting input terminal to which an output signal from the error amplifier 23 is supplied, and supplies an output signal to the gate of the FET 2.

A negative feedback circuit in which a resistor R6 is connected in parallel to a resistor R5 and a capacitor C2, which are connected in series, may be externally added to the error amplifier 23, and the gain of the error amplifier 23 is small.

The control unit 10 controls the target voltage ref1 of the step-up PWM signal generation circuit 7 and the target voltage ref2 of the step-down PWM signal generation circuit 8 by adding a predetermined amount of difference, so that ref1<ref2 is satisfied. However, the difference between the target voltages ref1 and ref2 is assumed to be sufficiently smaller than the crest values of the triangular wave signals W1 and W2.

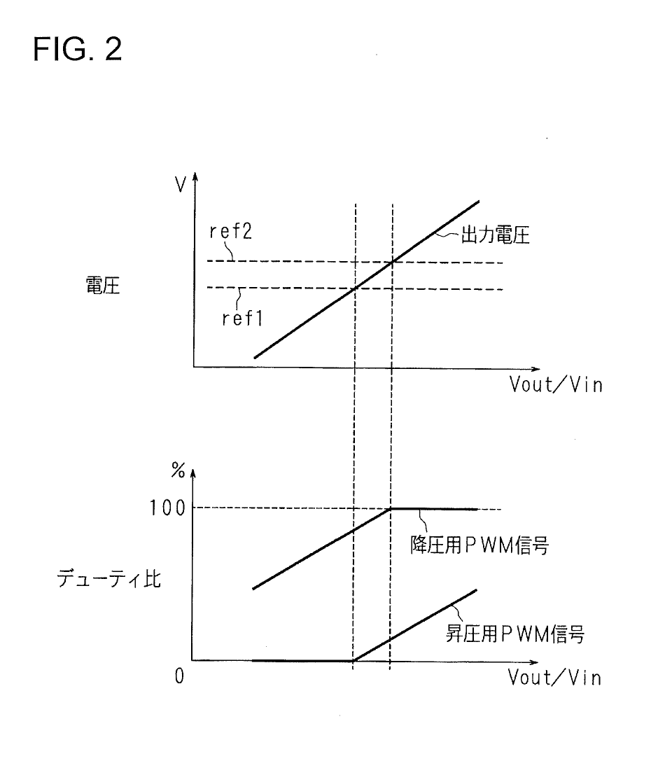

Accordingly, as shown in FIG. 2, the state in which the duty ratio of a PWM signal generated by the step-up PWM signal generation circuit 7 is greater than the lower limit (0%), and the state in which the duty ratio of a PWM signal generated by the step-down PWM signal generation circuit 8 is smaller than the upper limit (100%) occur at the same time, and in this situation in which these states are occurring, switching between step-up conversion and step-down conversion may be performed.

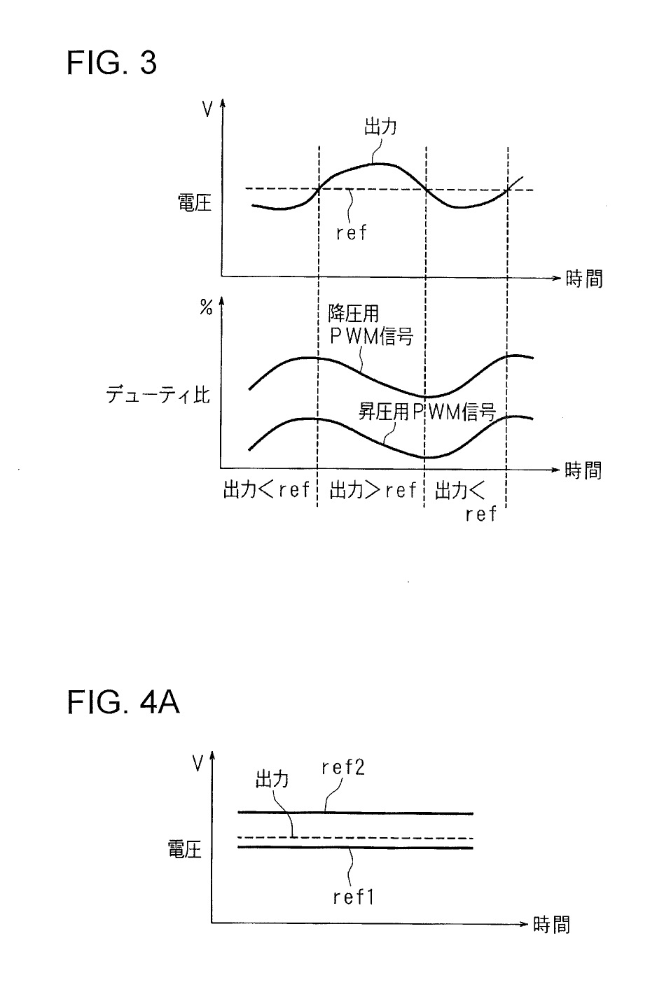

If the step-up PWM signal generation circuit 7 and the step-down PWM signal generation circuit 8 would operate individually and the target voltages ref were the same, an increase and a decrease in the duty ratios of a step-up PWM signal and a step-down PWM signal would be synchronized as shown in FIG. 3, and thus there would be the risk that both circuits wholly amplify the gain and oscillate. This oscillation can be avoided by controlling the target voltages ref1 and ref2 by adding a predetermined amount of difference, so that ref1<ref2 is satisfied.

In the voltage converter having such a configuration, by letting the output signals of the error amplifiers 13 and 23 change with a temporal lag in response to a change in the output voltage Vout, the duty ratios of the step-up PWM signal and the step-down PWM signal may change little by little.

When the output voltage Vout is higher than the target voltages ref1 and ref2, the outputs of the error amplifiers 13 and 23 decrease and the duty ratios also decrease, but in response thereto, the output voltage Vout decreases and the duty ratios are inverted and increase (before the duty ratios reach 0%, the output voltage Vout becomes lower than the target voltage and the duty ratios are inverted and increase).

When the output voltage Vout is lower than the target voltages ref1 and ref2, both the step-up PWM signal generation circuit 7 and the step-down PWM signal generation circuit 8 operate to increase the duty ratios and boost the output voltage Vout.

When the output voltage Vout is higher than the target voltages ref1 and ref2, both the step-up PWM signal generation circuit 7 and the step-down PWM signal generation circuit 8 operate to decrease the duty ratios and drop the output voltage Vout.

In both cases where the output voltage Vout is lower than the target voltages ref1 and ref2, and is higher than the target voltages ref1 and ref2, the output voltage Vout changes toward the target voltages ref1 and ref2, and in both cases, the output voltage Vout is between the target voltages ref1 and ref2.

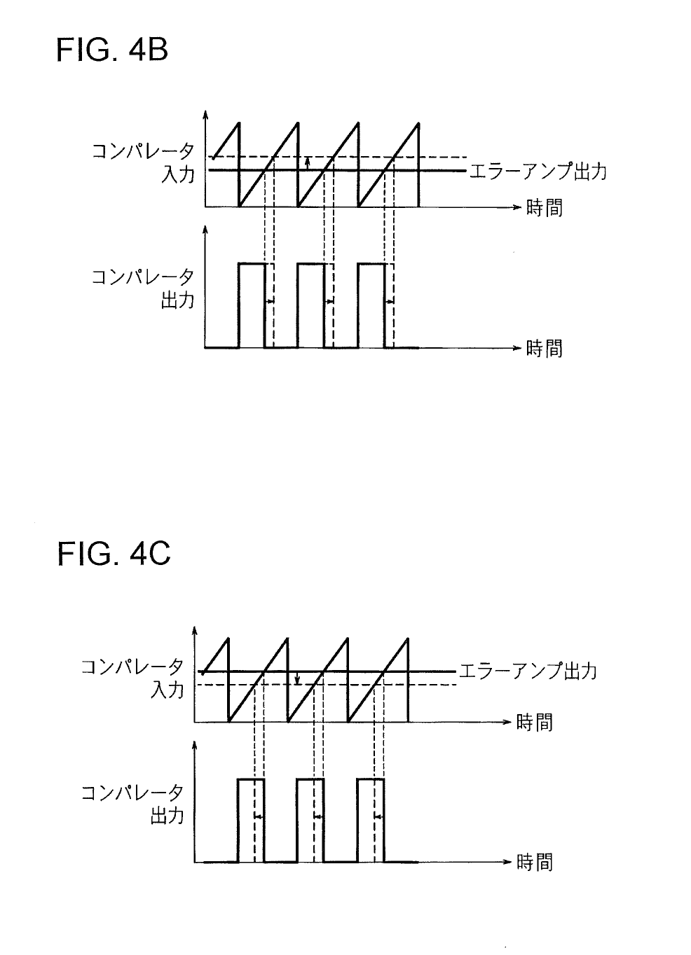

In the case where the output voltage Vout is between target voltages ref1 and ref2 as shown in FIG. 4A, if the output voltage Vout is close to the target voltage ref1, the output of the error amplifier 13 of the step-up PWM signal generation circuit 7 changes slightly but the step-down PWM signal generation circuit 8 increases the duty ratio because the output voltage Vout is lower than the target voltage ref2 (FIG. 4B). With the increase in the duty ratio of the step-down PWM signal generation circuit 8, the output voltage Vout may become much higher than the target voltage ref1, and the step-up PWM signal generation circuit 7 decreases the duty ratio (FIG. 4C).

On the other hand, in the case where the output voltage Vout is between the target voltages ref1 and ref2 as shown in FIG. 4A, if the output voltage Vout is close to the target voltage ref2, the output of the error amplifier 23 of the step-down PWM signal generation circuit 8 changes slightly but the step-up PWM signal generation circuit 7 decreases the duty ratio because the output voltage Vout is higher than the target voltage ref1 (FIG. 4C). With the decrease in the duty ratio of the step-up PWM signal generation circuit 7, the output voltage Vout becomes much lower than the target voltage ref2, and the step-down PWM signal generation circuit 8 increases the duty ratio (FIG. 4B).

Accordingly, when the output voltage Vout is between the target voltages ref1 and ref2, increases and decreases in the duty ratios of the step-up PWM signal generation circuit 7 and the step-down PWM signal generation circuit 8 may be in the opposite directions to each other.

If the gains of the error amplifiers 13 and 23 are large, continuing the operation may selectively cause the state in which the duty ratio of the step-up PWM signal generation circuit 7 decreases completely, or the state in which the duty ratio of the step-down PWM signal generation circuit 8 increases completely, converging to the step-up operation or the step-down operation depending on the dimensional relationship of the current input voltage Vin and target voltages ref1 and ref2.

If the input voltage Vin is higher than the target voltage ref2, the output voltage Vout and the target voltage ref2 are in the equilibrium state when the duty ratio of the step-up PWM signal generation circuit 7 is a lower limit (for example, 0%) and the duty ratio of the step-down PWM signal generation circuit 8 is a suitable value. The voltage converter is in the state of executing the step-down operation.

If the input voltage Vin is lower than the target voltage ref1, the output voltage Vout and the target voltage ref1 is in the equilibrium state when the duty ratio of the step-down PWM signal generation circuit 8 is at an upper limit (for example, 100%) and the duty ratio of the step-up PWM signal generation circuit 7 has a suitable value. The voltage converter is in the state of executing the step-up operation.

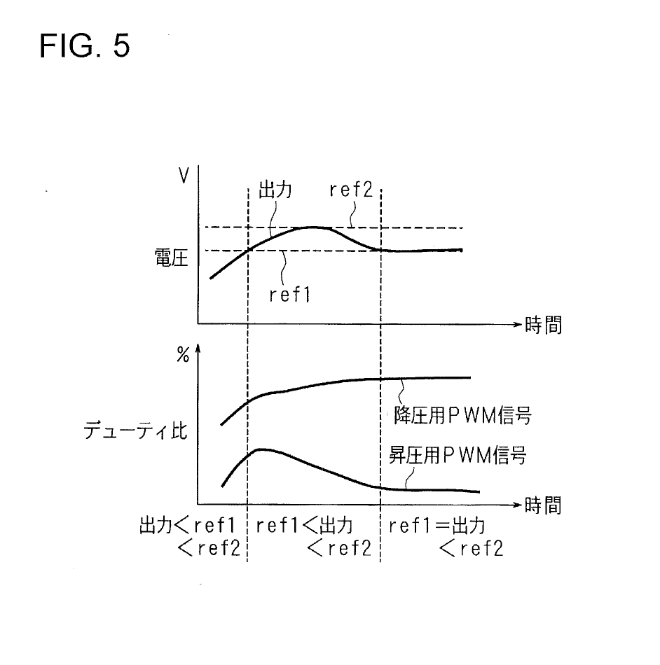

As described above, as shown in FIG. 5, when the output voltage Vout is between the target voltages ref1 and ref2, increases and decreases in the duty ratios of the step-up PWM signal and the step-down PWM signal may be in the opposite directions to each other, and the output voltage Vout may change slightly (gain decrease), making it possible to prevent the voltage converter from oscillating.

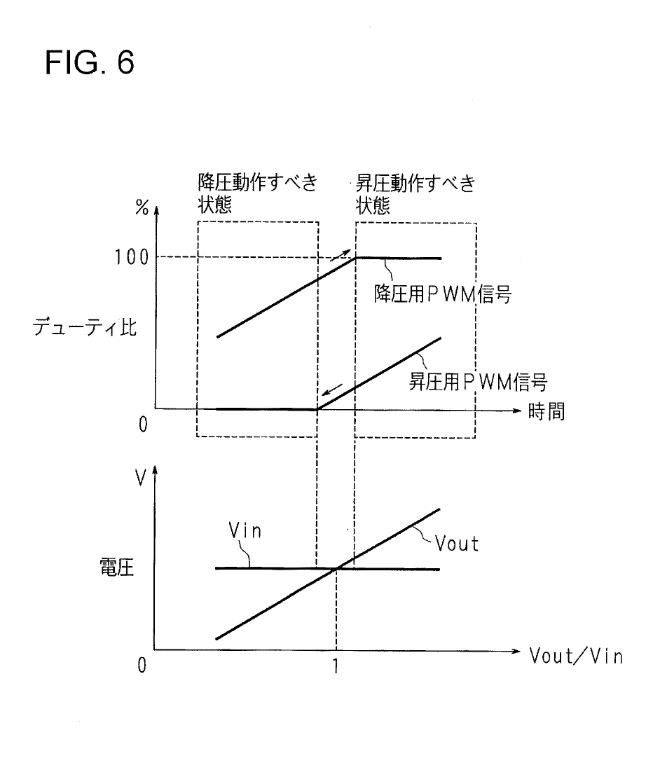

When any one of the duty ratios of the step-up PWM signal and the step-down PWM signal reaches the upper limit or the lower limit, the operation is stabilized at the output voltage Vout of the other target value, and thus, as shown in FIG. 6, it is possible to switch seamlessly between the step-down conversion and the step-up conversion.

If the step-up PWM signal generation circuit 7 and the step-down PWM signal generation circuit 8 operate individually, there may be numerous combinations of the duty ratios of the step-up PWM signal and the step-down PWM signal in order to obtain a given output voltage Vout. However, this problem can be solved by setting the lower limit for the duty ratio of the step-up PWM signal to 0% and the upper limit for the duty ratio of the step-down PWM signal to 100% in the above-described method.

Assuming that the duty ratio of the step-up PWM signal is Dboost, and the duty ratio of the step-down PWM signal is Ddrop, the relationship between the input voltage Vin and the output voltage Vout is given as follows:

Vout=Vin×Ddrop×1/(1·Dboost)

Vout=Vin×2 can be obtained even when Ddrop=100% and Dboost=50%, or when Ddrop=50% and Dboost=75%, for example.

In the state in which the duty ratio is not 100% or 0%, the FETs 2 and 3 perform switching, and in such a case (50%, 75%, or the like), unnecessary switching loss occurs and, therefore, in some emobdiments, the duty ratio may be 100% or 0%.

### Embodiment 2

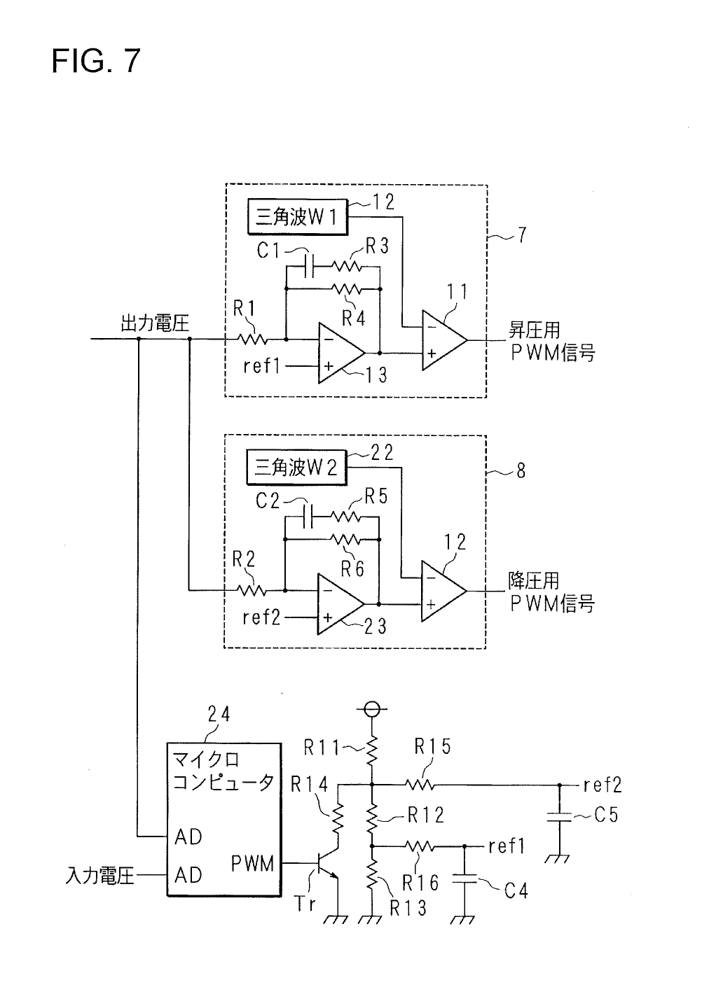

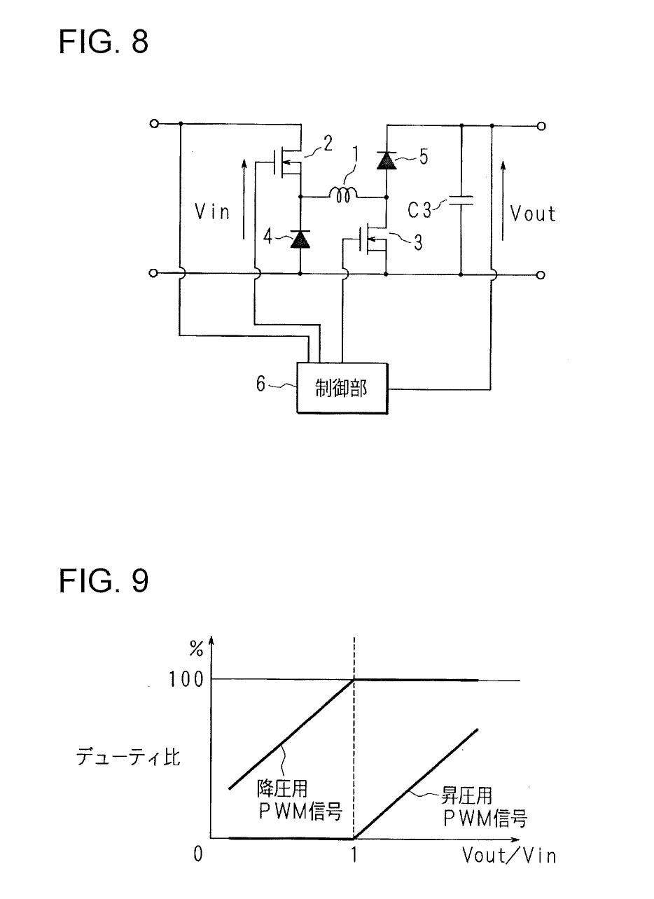

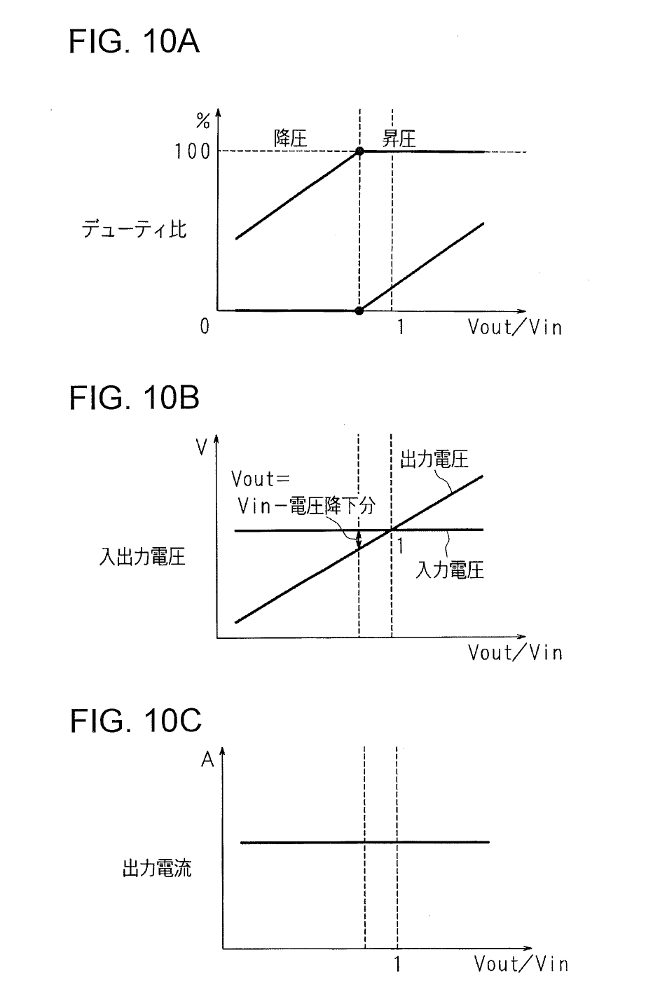

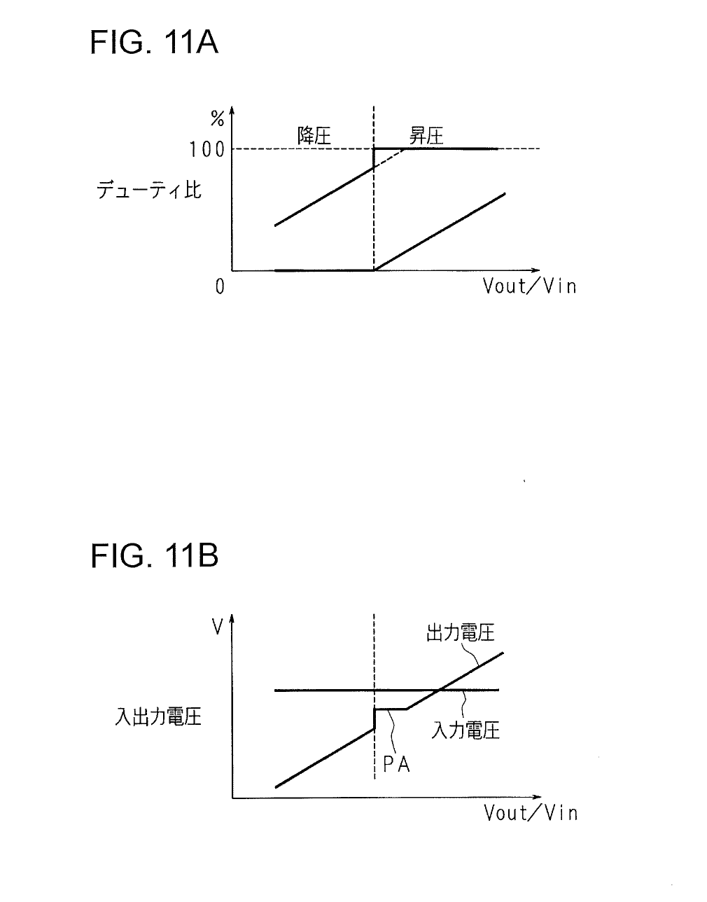

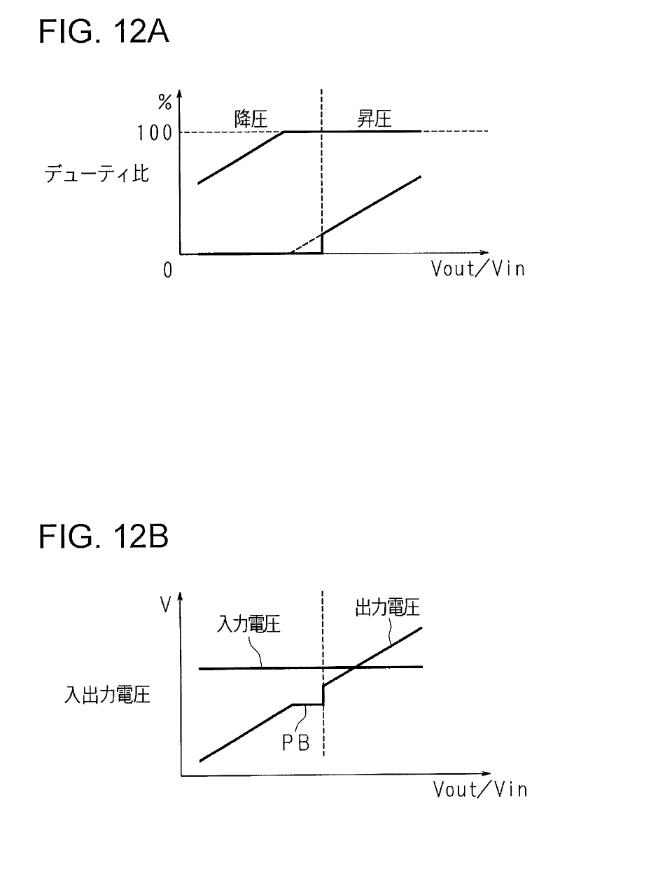

FIG. 7 is a circuit diagram illustrating an internal configuration of a control unit 10 of a voltage converter according to Embodiment 2.

This control unit 10 may include a microcomputer 24 that is supplied with an input voltage Vin and an output voltage Vout individually and reads them. The microcomputer 24 may set target voltages based on the read input voltage Vin and output voltage Vout, generates a PWM signal in order to obtain the target voltages, and performs switching of an NPN-type transistor Tr based on the generated PWM signal.

The emitter of the transistor Tr may be grounded, and the collector thereof may be connected to a control power supply via resistors R14 and R11. A voltage-dividing circuit of the resistors R11, R12, and R13, a voltage-dividing circuit of the resistors R11, R12, and R16, and a capacitor C4, and a voltage-dividing circuit of the resistors R11 and R15, and a capacitor C5 may be formed between the control power supply and ground terminals.

A target voltage ref1 is obtained from the positive terminal of the capacitor C4, and may be supplied to the non-inverting input terminal of the error amplifier 13. A target voltage ref2 is obtained from the positive terminal of the capacitor C5, and may be supplied to the non-inverting input terminal of the error amplifier 23.

The microcomputer 24 may perform switching of the transistor Tr based on the generated PWM signal to generate predetermined voltages in the voltage-dividing circuit, and the target voltages ref1 and ref2 having a predetermined amount of difference are generated with the corresponding voltage-dividing circuits based on the generated voltages. Other configurations and operations are the same as the configurations and operations of Embodiment 1 described above, and thus descriptions thereof are omitted.

### INDUSTRIAL APPLICABILITY

The present invention is applicable to a voltage converter that is configured to boost or drop a voltage in a power supply device installed in a vehicle.

### LIST OF REFERENCE NUMERALS

1 Coil
2, 3 FET
4, 5 Diode
7 Step-up PWM signal generation circuit
8 Step-down PWM signal generation circuit
10 Control unit (means for making a voltage larger by a predetermined amount)
11, 21 Comparator
12, 22 Triangular wave generator circuit
13, 23 Error amplifier
C3 Smoothing capacitor

1. A voltage converter that subjects an input voltage to step-down conversion or step-up conversion to obtain a target voltage, and outputs the obtained voltage, the voltage converter comprising:
a step-down switching element and a step-up switching element that are respectively configured to perform, with PWM control, switching of the input voltage, and switching between the input voltage and a fixed potential with PWM control in order to increase or decrease the input voltage;
a component configured to change a target voltage;
a step-down PWM signal generation circuit configured to detect a difference between an output voltage obtained by subjecting the input voltage to the step-down conversion and a step-down target voltage, and to generate a PWM signal for use in the PWM control of the step-down switching element based on the detected difference;
a step-up PWM signal generation circuit configured to detect a difference between an output voltage obtained by subjecting the input voltage to the step-up conversion and a step-up target voltage, and to generate a PWM signal for use in the PWM control of the step-up switching element based on the detected difference; and
a component configured to make the step-down target voltage, which is a target for the control by the step-down PWM signal generation circuit, larger by a predetermined amount than the step-up target voltage, which is a target for the control by the step-up PWM signal generation circuit,
wherein when the step-down target voltage and the step-up target voltage are changed, switching between the step-down conversion and step-up conversion of the input voltage is performed in a constant manner.
